(19) United States
(12) Patent Application Publication
(10) Pub. No.: US 2017/0241218 A1
(43) Pub. Date: Aug. 24, 2017

(54) WELL FLUID TREATMENT AND STEAM GENERATION USING CAVITATION

(71) Applicant: HST Asset Holdings LLC, Las Vegas, NV (US)

(72) Inventor: Justin McKie, Wichita Falls, TX (US)

(21) Appl. No.: 15/049,447

(22) Filed: Feb. 22, 2016

(51) Int. Cl. E21B 21/06; E21B 43/26; B01D 1/00; E21B 43/34

(52) U.S. Cl. CPC E21B 21/063; E21B 43/34; E21B 43/26; B01D 1/0041; B01D 1/0017

(57) ABSTRACT

A well fluid treatment system includes a cavitation reactor causing cavitation-induced heating of a flow sufficient to convert at least a portion of water in the well fluid to steam a single pass of the well fluid through the cavitation reactor, a steam-liquid phase separator receives the heated well fluid and separates the flow into steam and a condensed contaminated fluid. One or more auxiliary systems are coupled to the steam outlet and receive the flow of steam in order to transfer thermal energy from the flow of steam to one or more of the following: (a) a well fluid treatment process before the cavitation reactor, and (b) a condensed contaminated fluid treatment process after the cavitation reactor.

### FIELD

The present disclosure concerns well fluid treatment and purification using cavitation heating.

### BACKGROUND

Conventional thermal treatment techniques for purification of well fluids typically involves directly heating the well fluid at a solid interface between a heat source and the subject fluid. However, directly heating well fluids, such as drilling fluids, completion fluids, and frac fluids, results in heat exchanger scaling and, as a result, significant maintenance. Additionally, direct heating systems are often sensitive to the particulate matter concentrations of the subject fluid. Cavitation-induced heating eliminates the solid heat transfer interface by inducing heat transfer directly within the fluid. Typical cavitation devices are able to heat fluids by mechanically generating cavitation bubbles, whose collapse releases energy directly into the fluid as heat. This cavitation-induced heat can generate steam with sufficient cavitation intensity or duration.

### SUMMARY

The concepts herein encompass using a cavitation device to treat a contaminated well fluid by heating the contaminated fluid and producing steam. The generated steam is captured and used to power auxiliary systems and collected as a source of purified water. The generated steam is also able to improve the efficiency of the overall system by, for example, driving a steam generator to supplement the power of the cavitation device or other treatment processes upstream or downstream of cavitation device.

One application of cavitation is the use of cavitation heating to purify polluted water through distillation. Cavitation heating may be used to purify water that produced in a hydraulic fracturing (“fracking”) processes. The produced fluid used in the fracking process is typically returned to the surface contaminated, often with salt and other minerals, and must be treated before being introduced back into the environment or disposed of Aspects of the present disclosure include treating contaminated fluids with cavitation-induced heating by separating water from the contaminates in the fluid by vaporizing the water as steam, and using the steam as both a source of purified water and as a source of thermal energy for driving auxiliary treatment processes in the purification system.

In an example, a well fluid treatment system comprises a cavitation reactor, a steam-liquid phase separator, and an auxiliary system coupled to a steam outlet of the cavitation reactor to receive a flow of steam. The auxiliary system is adapted to transfer thermal energy from the flow of steam to one or more of the following: (a) a well fluid treatment process before the cavitation reactor, and (b) a condensed contaminated fluid treatment process after the cavitation reactor. The cavitation reactor comprises a reaction chamber housing, a rotor and a stator mounted in the reaction chamber housing, a well fluid inlet into the reaction chamber housing and a heated fluid outlet from the reaction chamber housing, the cavitation reactor configured to cause cavitation of a flow of well fluid received through the well fluid inlet and transfer sufficient thermal energy to the flow of well fluid to convert at least a portion of water in the well fluid to steam in a single pass of the well fluid through the cavitation reactor. The steam-liquid phase separator comprises a separator housing, a heated well fluid inlet into the separator housing, a steam outlet from the separator housing, and a residual outlet from the separator housing, the heated well fluid inlet coupled to the heated fluid outlet to receive the flow of heated well fluid from the cavitation reactor, the steam-liquid phase separator configured to separate the flow of heated fluid into steam and a condensed contaminated fluid.

In some examples, the cavitation reactor is a continuous cavitation reactor, and the continuous cavitation reactor is adapted to heat an uninterrupted flow of the well fluid into an uninterrupted flow of steam. The cavitation may be in the form of hydrodynamic cavitation or both hydrodynamic cavitation and acoustic cavitation.

In some embodiments, the auxiliary system includes a steam tracing system comprising a plurality of steam conduits adapted to variably transfer thermal energy from the flow of steam to adjacent fluid conduits of the well fluid treatment system, the steam tracing system enabling temperature regulation of a fluid in the adjacent fluid conduits.

In some examples, the auxiliary system includes a heating system of the phase separator, the heating system adapted to regulate the temperature of one or more fluids in the phase separator using thermal energy from the flow of steam.

In some examples, the auxiliary system is adapted to heat an interior volume of one or more buildings.

In some examples, the auxiliary system includes a steam turbine adapted to convert thermal energy from the flow of steam into mechanical energy. The steam turbine may include a mechanical coupling to a motor driving the rotor of the cavitation reactor, the mechanical coupling enabling mechanical energy from the steam turbine to supplement the motor. The steam turbine may include a mechanical coupling to a generator, with the generator adapted to generate electrical energy from the steam turbine via the mechanical coupling, and the generator enabling the electrical energy to partially power an electric motor driving the rotor of the continuous cavitation reactor.

In some examples, the auxiliary system includes a heat exchanger adapted to heat the flow of well fluid prior to the cavitation reactor or another process.

In some examples, the auxiliary system includes an absorption chiller adapted to convert the thermal energy from the flow of steam to chill fluids.

In some examples, the well fluid contains oil, and the phase separator is further adapted to separate the oil from the condensed contaminated fluid. The system may include a settling tank coupled to the well fluid inlet of the cavitation reactor, and wherein the auxiliary system may be a steam-driven agitator in the settling tank, whereby the steam-driven agitator is adapted to separate at least some of the oil from the flow of well fluid prior to the cavitation device. In some embodiments, the auxiliary system includes a heating system adapted to dry the condensed contaminated fluid and separate remaining water from the oil. In some embodiments, the well fluid contains salt.

In some examples, the system includes a dirt separator for receiving the flow of well fluid, the separator adapted to remove solids from the well fluid prior to being received by the cavitation reactor.

In some examples, the system includes a condenser for receiving the flow of steam, the condenser adapted to generate a liquid water from the received flow of steam.

In some examples, the system includes a dryer for receiving the flow of steam from the phase separator, the dryer adapted to remove liquid water from the steam and produce dry steam.

Another example is a method of treating well fluid comprising causing cavitation in a flow of well fluid through a cavitation reactor, the cavitation transferring energy to the flow of well fluid sufficient to convert at least a portion of water in the well fluid to steam in a single pass of the well fluid through the cavitation reactor, separating the flow of heated fluid into steam and a condensed contaminated fluid, and transferring thermal energy from the flow of steam to an auxiliary process doing one or more of the following: (a) treating the well fluid before the cavitation reactor, and (b) treating the condensed contaminated fluid after the cavitation reactor.

In some examples, the method includes causing continuous cavitation in an uninterrupted flow of well fluid.

In some examples, the auxiliary process flows the steam through a plurality of steam conduits adjacent to fluid conduits of the well fluid treatment system, the axillary process regulating the temperature of a fluid in the adjacent fluid conduits. In some embodiments, the auxiliary process includes regulating the temperature of one or more fluids in a phase separator receiving the flow of heated fluid. In some embodiments, the auxiliary process includes heating an interior volume of one or more buildings. In some embodiments, the auxiliary process includes converting thermal energy from the flow of steam into mechanical energy.

In some examples, the method further includes partially causing the cavitation with the mechanical energy. In some embodiments, the method includes generating electrical energy from the mechanical energy, converting the electrical energy into mechanical energy, and partially causing the cavitation with the mechanical energy.

Yet another example is a well fluid treatment system comprising a cavitation reactor causing cavitation of a flow of well fluid received through the well fluid inlet and heating the flow of well fluid to a temperature sufficient to generate steam in a single pass of the well fluid through the cavitation reactor, a steam-liquid phase separator separating the flow of heated fluid into steam and a condensed contaminated fluid, and an auxiliary system coupled to the steam outlet and receiving a flow of steam, the auxiliary system transferring thermal energy from the flow of steam to one or more of the following: (a) a well fluid treatment process before the cavitation reactor, and (b) a condensed contaminated fluid treatment process after the cavitation reactor.

Some, none or all of the aforementioned examples, and examples throughout the following descriptions, can be combined.

### BRIEF DESCRIPTION OF DRAWINGS

FIG. 1 is a piping and instrumentation diagram of a basic cavitation fluid treatment system.

FIG. 2 is a piping and instrumentation diagram of a cavitation fluid treatment system with feedstock preheating using produced steam.

FIG. 3 is diagram of a variable diameter cavitation reactor.

FIG. 4 is a piping and instrumentation diagram of a salt-water disposal facility with a cavitation fluid treatment system.

FIGS. 5A-5C are piping and instrumentation diagrams of a salt-water disposal facility with a cavitation fluid treatment system with a plurality of auxiliary steam-powered processes.

### DETAILED DESCRIPTION

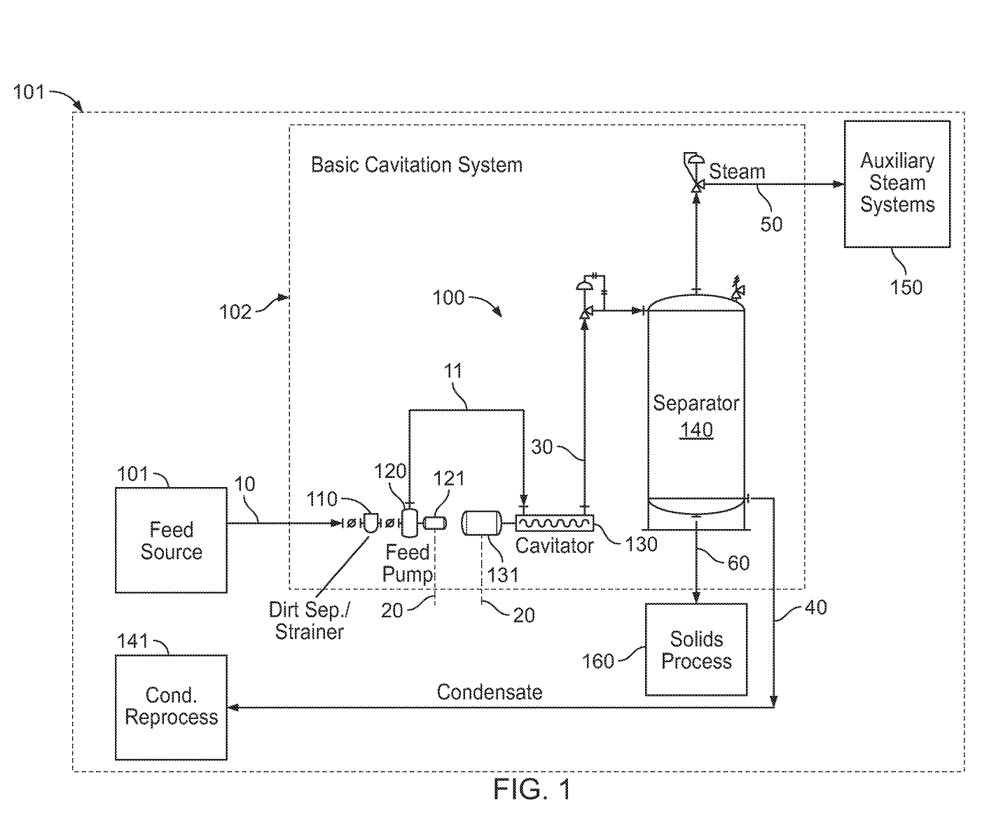

FIG. 1 is a piping and instrumentation diagram of a basic cavitation fluid treatment system. Cavitation heating has a number of advantages. For example, cavitation-induced heating allows fluids to be heated directly in-line without heat exchanger scaling and needing only a source of mechanical energy to rotate the internal components of the cavitation device. FIG. 1 shows a cavitation fluid treatment system 100 at a well wastewater disposal site 101, such as a well salt-water disposal site. The cavitation fluid treatment system 100 includes a cavitation device 130, a feed source 101 of fluid, e.g. through source conduit 10, to be treated, a separator 140, a condensate reprocessing system 141, a solids reprocessing system 160, and auxiliary steam system 150. In certain instances, the feed source 101 is brine recovered from a well, such as typically recovered with oil and gas produced from the well. In certain instances, the feed source 101 can also or alternatively include drilling fluid or water such as used to flush cuttings from within a well bore being drilled, frac fluid or water such as used during fracture stimulation treatment of a well, completion fluid such as used during the completion of a well, and/or other waste well fluids. Often the feed source 101 is a pool or a tank that contains the fluid at the disposal site 101, but the feed source 101 could take another form. The disposal site 101 can be at the well site, associated with the well site or at a location apart from the well site. The separator 140 may be, for example, a two-phase (e.g., gas-liquid) or three-phase (e.g., gas-oil-water) separator. The separator 140 is able to accept a heated fluid feedstock though conduit 30 from the cavitation reactor 130 and separate the heated fluid feedstock from conduit 30 into steam in conduit 50, condensate fluid in conduit 40, and solids in conduit 60.

In operation, a feed pump 120 is coupled to the source conduit 10 to draw the fluid feedstock 10 through a dirt separator 110 to remove any large particulate matter in the fluid feedstock, for example, rocks larger than the passageways of the cavitation reactor, and provide the strained fluid feedstock, via conduit 11, to the cavitation reactor 130. In certain instances, the dirt separator 110 is a screen or other coarse filter arranged to filter particular larger than the spacing between the rotor and external casing/ring from the fluid feedstock. The feed pump 120 is driven by a pump motor 121, which is powered by a source of electric power 20, which in certain instances is a generator, solar cells, battery, or a connection to a local power grid. The cavitation reactor 130 is powered by a cavitation drive motor 131, which is also powered by the source of electric power 20 or another source. The cavitation reactor 130 causes cavitation-induced heating to take place in the strained fluid feedstock, which generates a flow of heated feedstock at a temperature and pressure sufficient to vaporize at least a portion of the water content of the heated feedstock in a single pass through the cavitation reactor 131. In some instances, the cavitation reactor 130 raises the heated feedstock to a temperature sufficient to convert 100% of the water content of the heated feedstock to steam at atmospheric pressure. In other instances, the cavitation reactor raises the temperature of the heated feedstock to a temperature sufficient to convert at least 50% of the water content of the heated feedstock to steam at atmospheric pressure. In some instances, the cavitation reactor accepts a continuous uninterrupted flow of well fluid and continuously heats the well fluid to generate an uninterrupted flow of heated feedstock in conduit 30. The heated feedstock in conduit 30 is delivered from the cavitation reactor 130 to the separator 140, where it is able to expand and form steam that exits the separator 140 through conduit 50. Non-water fluids that survive the cavitation process and possibly a portion of the water are separated from the steam as condensate fluids in conduit 40. Additionally, any particulate matter remaining (or created by the heat of cavitation) in the condensate fluid are able to settle in the separator 140 and are removed as solids through conduit 60. As noted above, in some instances, the separator 140 is a three-phase separator that is able to separate oils or other petroleum products from the heated feedstock.

The auxiliary steam systems 150 accepts the steam from conduit 50 to recoup the thermal energy of the steam and generate purified water from the steam's condensate. The condensate reprocessing system 141 accepts the flow of condensate fluid in conduit 40 from the separator, and, in some instances, provides (i) further processing of the condensate fluid to remove petroleum byproducts, (ii) drying of the condensate fluid, or (iii) storage of the condensate fluid 40 for removal. Similarly, the solids processing system 160 accepts the solids from conduit 60 from the separator 140 and in some instances provides, for example, further processing or storage of the solids. The entire cavitation fluid treatment system 100 in some instances is packaged as single system on a skid 102 or frame with interconnecting piping and fittings as described above.

The auxiliary systems 150 in some instances utilize the steam for many applications. For example, a low pressure steam generator to produce electrical power 20, which, in some instances, is sent back to the treatment facility to supplement the cavitation reactor 130 or any others machines. Other examples of auxiliary systems 150 include treatment processes using thermal energy from the steam 50 to prevent freezing of fluids or to improve flow, steam powered pumps that may supplement the cavitation drive motor 131 or any other mechanically driven process, HVAC heating and cooling, process heating or preheating the fluid feedstock to improve cavitation reactor efficiency.

Example applications for the cavitation fluid treatment system 100 include salt water disposal, desalinization, HVAC heating and cooling, marine, oil and gas, power generation, beverage processing, industrial/process, waste water treatment, and disaster clean up. Desalinization is a similar same process as salt-water disposal, but with seawater as opposed to process fluids. The feed source is typically the ocean or other salt-water body of water. In HVAC application, steam can be used to heat a separate loop through heat exchangers, a closed loop system where the water never leaves/flashes. Cooling with cavitation fluid treatment system 100 can be done through using the generated steam to power an absorption chiller. In some instances, the cavitation fluid treatment system 100 is used to refine oil. In some instances, the cavitation fluid treatment system 100 is used in the food and beverage industry to heat fluids where scaling is a concern, for example, chocolate. With respect to disaster clean up, the cavitation fluid treatment system 100 skid 102 is powered remote via solar, wind, or generator power 20. In some instances, the skid 102 is drop shipped into a disaster area to provide clean fresh water, hot water, steam, and or treat contaminated water sources.

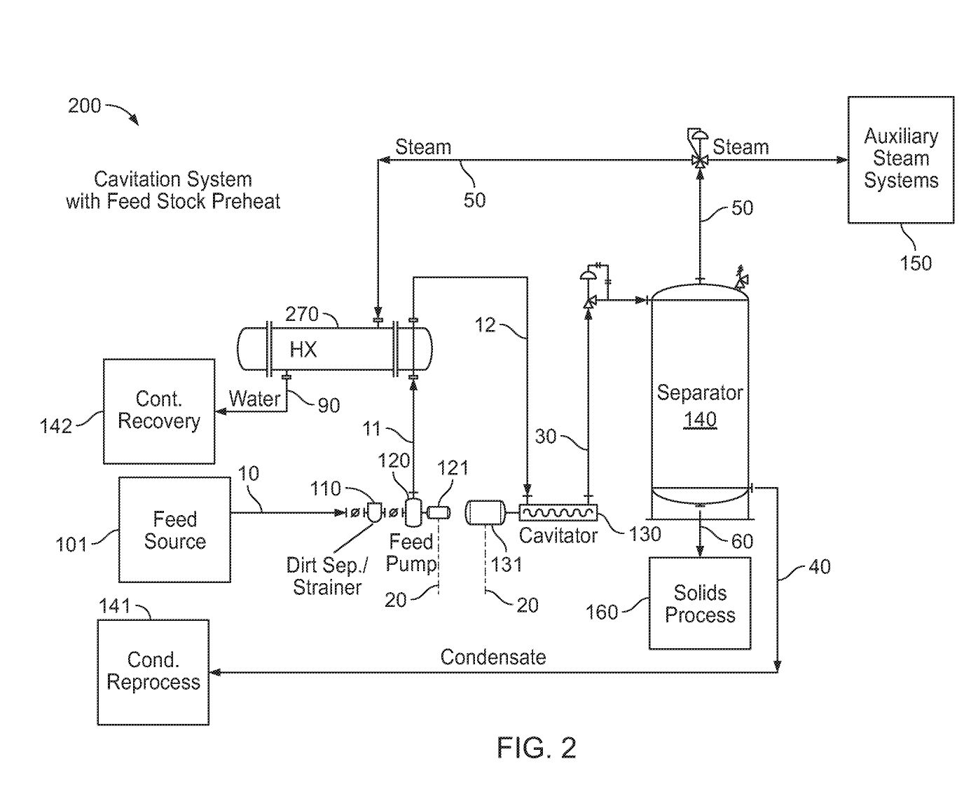

FIG. 2 is a piping and instrumentation diagram of a cavitation fluid treatment system with feedstock preheating using produced steam. FIG. 2 shows a preheated cavitation fluid treatment system 200 including a heat exchanger 270 and a condensate recovery system 142. In operation, the heat exchanger 270 accepts the flow of strained fluid feedstock through conduit 11 from the feed pump 120 and adds thermal energy to the strained fluid feedstock using steam in conduit 50 from the separator 140. A preheated fluid feedstock in conduit 12 leaves the heat exchanger 270 and enters the cavitation reactor 130 to generate the heated feedstock in conduit 30. The steam from conduit 50 exits the heat exchanger 270 as water in conduit 90, which, in some instances, is entirely liquid water, entirely low temperature steam, or a mix of liquid and low temperature steam. The water in conduit 90 is processed by the condensate recovery system 142, which in some instances, for example, converts the water from conduit 90 to potable liquid water and store the water for later collection or use.

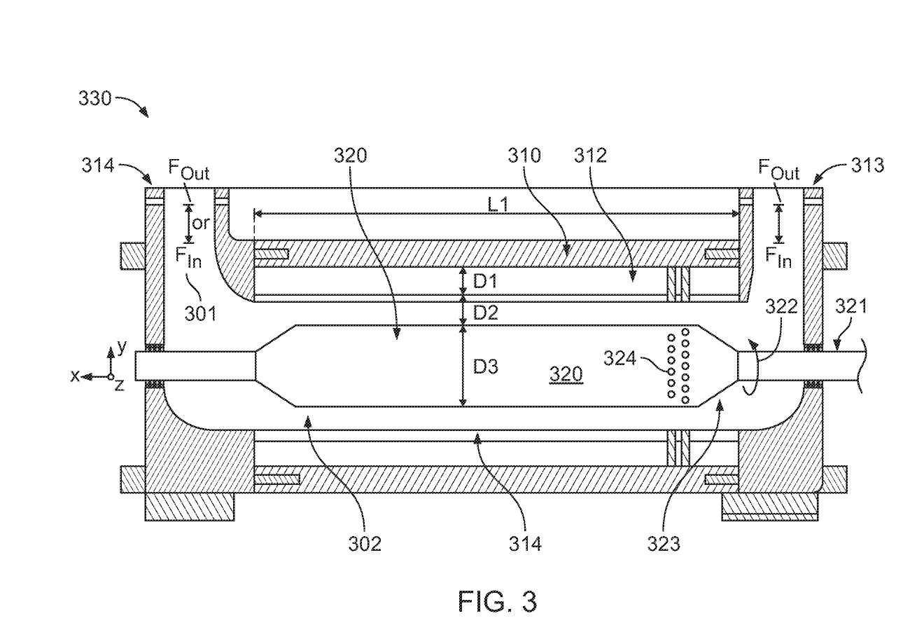

FIG. 3 is diagram of a variable diameter cavitation reactor. FIG. 3 shows a variable diameter cavitation device 330 including an exterior casing 310, a fluid inlet 313, and fluid outlet 314, and a rotor 320 positioned inside the exterior casing. The rotor 320 is adapted to spin 322 via input shaft 321 inside the casing 310. The rotor includes flow cones 323 at opposite ends of the rotor 320, and a plurality of cavitation-inducing features 324 on the surface of the rotor 320 and casing 310. The casing 320 surrounds the rotor 320 leaving only a small passageway 302 between the curved surfaces of the rotor 320 and casing 310. The casing in some instances includes a variable diameter sleeve 312 surrounding the rotor 320 and/or an insert 314 as required. The casing 310 alone can establish the outer diameter spacing or insert sleeves 314 can be used to vary the diameter while keeping the casing 310 the same. The variable diameter sleeve 312 in some instances allows for different sizes of solids present in the fluid, to reduce shearing effects, if desired (by increasing the width of clearance 12), or to vary the velocity of the rotor as a function of the fluid's properties, or for any other reason.

In operation, a flow of fluid, for example, fluid feedstock 10, is provided to the cavitation reactor 330 at the inlet 313 and the flow of fluid passes around the flow cone 323 and into the passage 302 between the surface of the rotor 320 and the adjustable diameter sleeve 312. As the fluid passes from the inlet 313, through the passageway 302, and to the outlet 313, rotation of the rotor 320 and the cavitation-inducing features 324 creates localized regions of extremely low pressure, which momentarily causes cavitation bubbles to form in the fluid. The subsequent and violent collapse of the cavitation bubbles generates heat within the fluid from the mechanical energy of the spinning rotor 320. The intense heat and pressure of the act of cavitation is able to destroy organics that may be present in the fluid along with other compounds. Through the act of hydrodynamic cavitation, and/or secondary acoustic cavitation, the fluid is heated/pressurized to its point of vaporization. This varies depending on the fluid and other conditions such as temperature, humidity and pressure. The phase separator 140 will then remove the clean steam and separate out remaining solids (i.e. salt, metals, etc.). Solids present in the flow small enough to pass through the passageway 302 may pass unchanged.

The adjustable diameter sleeve 312 in some instances is a sleeve type insert into the external casing 310. This allows for simple modification of the device with change in fluid as opposed to completely new device or machining.

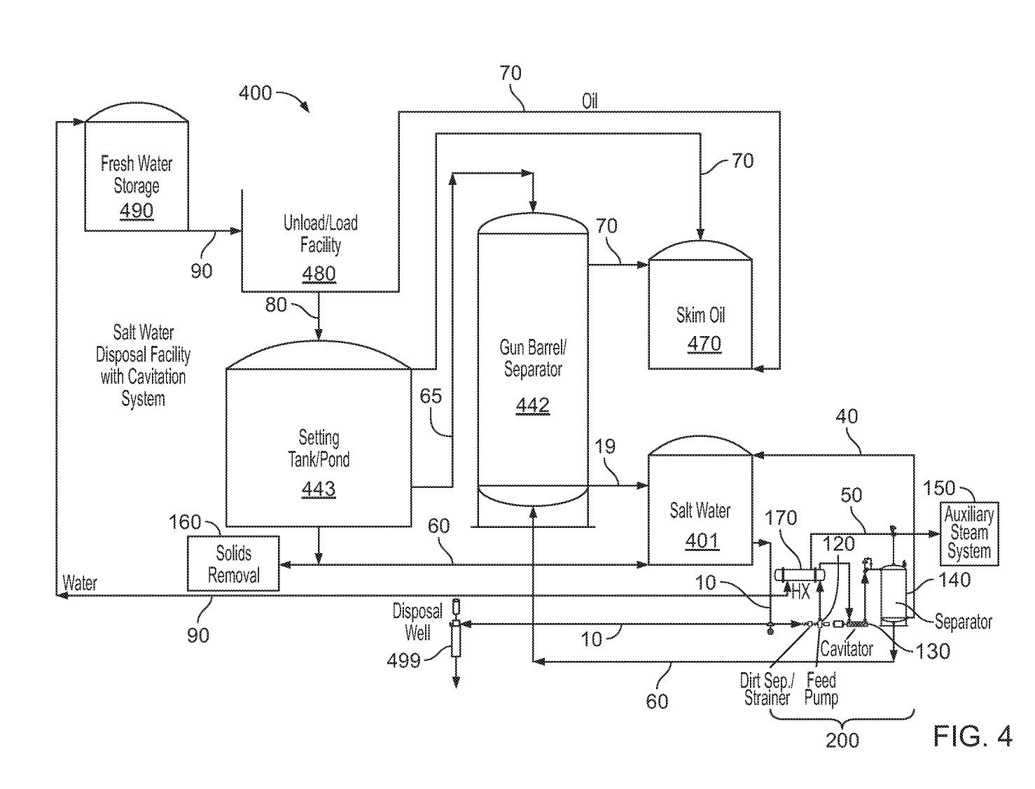

FIG. 4 is a piping and instrumentation diagram of a salt-water disposal facility with a cavitation fluid treatment system 200. Typical salt-water disposal facilities are used to dispose of produced water and flow back. Currently this is the only approved method of disposing of these types of fluids, by “disposing” of them back into the well site by injecting them back into a disposal well. Because these fluids typically contain oil, salt-water disposal facilities are often designed to recover as much oil as possible from the fluids. The oil recovered can be a revenue generator for the salt-water disposal facility operator, as they are being paid to remove the water from the well sites and any oil they recover is theirs to sell. Accordingly, the cavitation fluid treatment system 200 can help remove more oil from the water and increase the revenue for the salt-water disposal facility. Aspects of the design are for using cavitation technology as a purification component of the salt-water disposal facility 400, as used in the oil and gas industry. An example treatment process is detailed in FIG. 4. FIG. 4 shows the salt-water disposal facility 400 including a fresh water storage tank 490, a loading and unloading facility 480, a settling tank 443, a gun barrel separator 442, a skim oil storage tank 470, a salt-water holding tank 441, and a disposal well 499. The salt-water disposal facility 400 also includes a preheated cavitation fluid treatment system 200 processing the fluid feedstock 10 from the salt-water storage tank 401 and delivering a flow of purified water in conduit 90 to the fresh water storage tank 490.

In operation, flowback or produced fluid 80 is trucked or piped to a loading and unloading facility 480. From the unload facility 480, the produced water 80 is stored in a holding tank or settling pond 443 where the produced water 80 settles and oil 70 in some instances is skimmed from the surface and stored in the skim oil storage tank 470. From the settling pond 443, a contaminated feedstock 65 is delivered to the gun barrel separation device 442. The gun barrel separator 442 removes oils 70 from the produced fluid 80. In the gun barrel separator 442, contaminated salt-water 19 and oil 70 are separated, with oil 70 flowing to the top and contaminated salt-water 19 resting on bottom, which also enables solids 60 to be extracted. Once separated, the oil 70 in some instances is removed to the skim oil storage tank 470 for site removal at the loading and unloading facility 480. The remaining salt-water 19 is then transferred to the salt-water holding tank 401 and delivered to the preheated cavitation fluid treatment system 200 by the feed pump 120 as a fluid feedstock 10. Optionally, the fluid feedstock 10 can be delivered to a disposal well 499 for disposing of produced water and flowback. Disposal wells 499 typically return produced water back to the original well site and, in some instances, are old oil or gas well that are no longer producing. The use of the cavitation fluid treatment system 200 enables the volume of the produced water being disposed of and changes the concentration of the produced water by removing fresh water to be reused elsewhere.

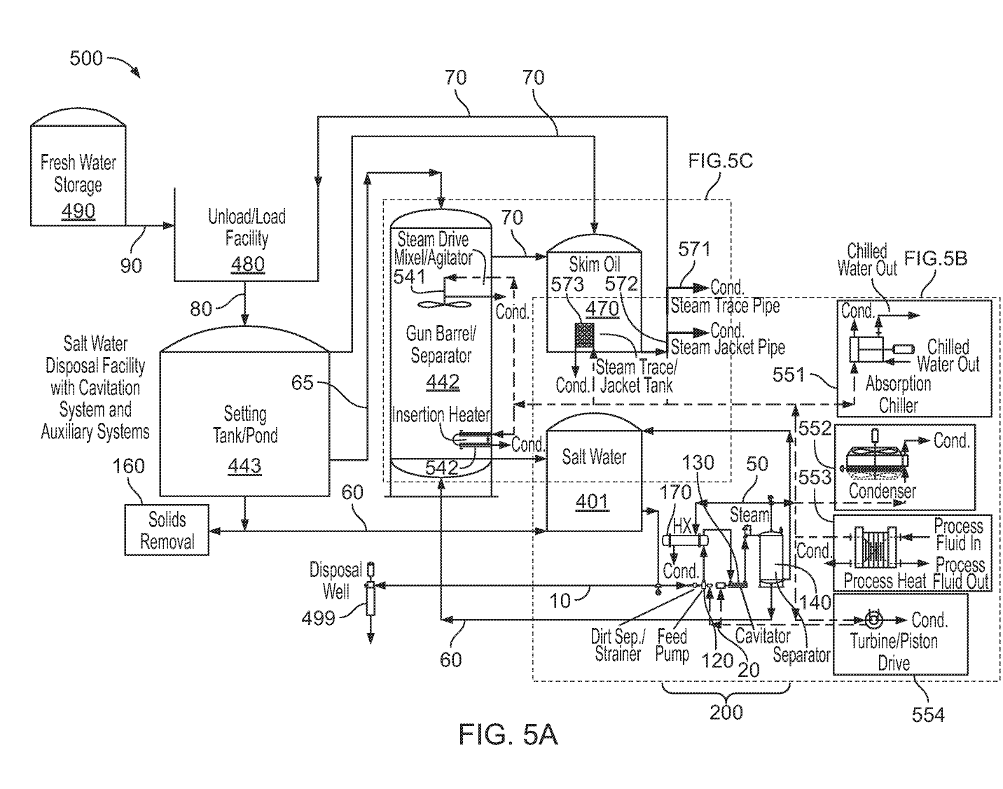

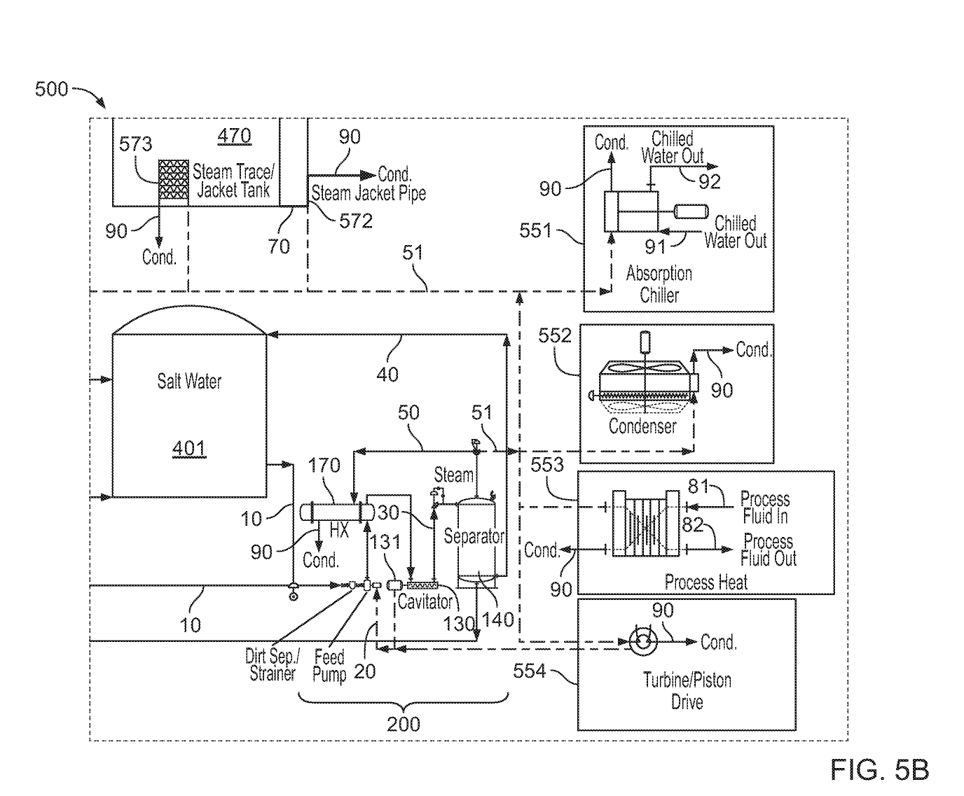

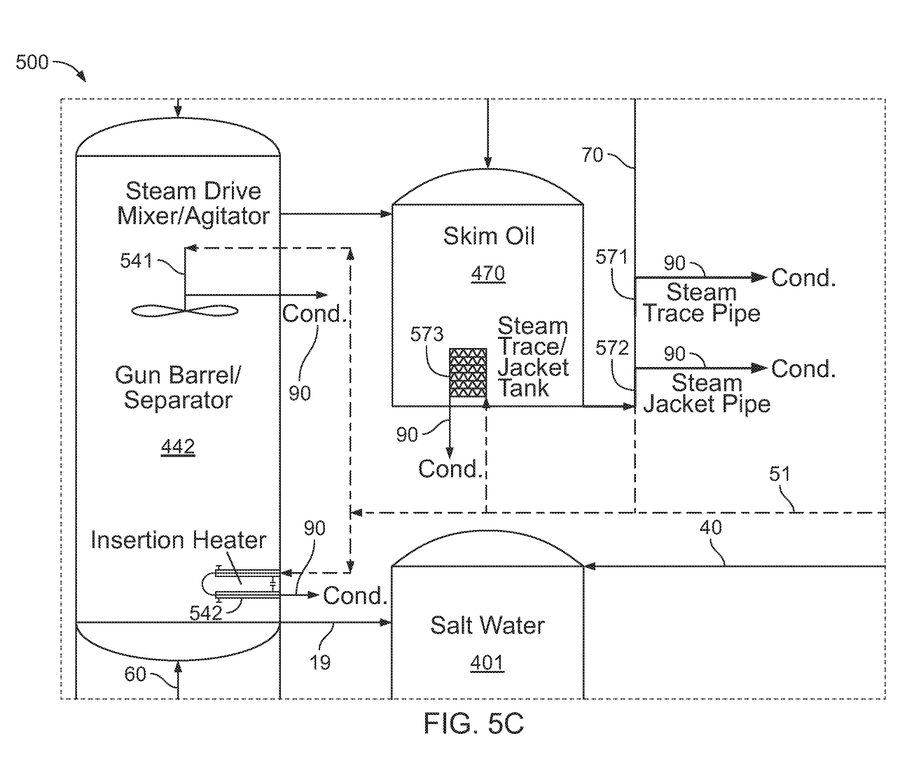

The feedstock in conduit 10 is delivered to the preheated cavitation fluid treatment system 200 and is preheated by the heat exchanger 170 and subsequently heated by the cavitation reactor 130 to a temperature sufficient to vaporize at least a portion of the water content in the feedstock, for example 230° F. The heated feedstock in conduit 30 is delivered to the separator 140, where the steam is separated from the condensate fluid and solids. The steam exits the separator 140 in conduit 50, the condensate fluid exists in conduit 40, and the solids exit in conduit 60. The condensate fluid in conduit 40, in some instances, is returned to the salt water holding tank 401, delivered directly to the disposal well 499, or further processed to remove any remaining water content. A portion of the steam in conduit 50, in some instances, and as detailed above in FIG. 2, is provided to the heat exchanger 170 to preheat the feedstock from conduit 10 prior to the cavitation reactor 130. Thermal energy added to the feedstock from conduit 10 by the heat exchanger 170, in some instances, improves the efficiency of the cavitation reactor 130 and enables increased vaporization of water, in the form of steam, from the heated feedstock in the separator 140 by increasing the temperature of the heated feedstock in conduit 30. The heat exchanger 170 removes thermal energy from the steam from conduit 50 and generates a flow of purified water in conduit 90 that is delivered to the fresh water storage tank 490. Additionally, the steam from conduit 50, in some instances, is delivered to various auxiliary systems 150, as detailed in FIGS. 5A-5C, as auxiliary steam in conduit 51.

Generally, placing the preheated cavitation fluid treatment system 200 at an existing salt-water disposal facility 400 (i.e., settling pond 443, gun barrel separator 442, and disposal well 499), is optimal for installation of the preheated cavitation fluid treatment system 200 to utilize existing equipment to reduce operating costs. In some aspects, installing a secondary branch of the discharge of the saltwater holding tanks 401 will provide the required feedstock for the system while still allowing normal salt-water disposal operation. This configuration provides a constant flow of feedstock we need, without interference with the standard salt-water disposal operations, but reduces the amount of salt-water that is disposed into the well 499. Alternately, if the discharge from the gun barrel 442 separator 442 is sufficient the cavitation fluid treatment system 200 can replace the storage tanks and pull feedstock directly from the gun barrel separator 442. In addition, depending on system capacities and salt-water disposal facility 400 throughput, the cavitation system, in some instances, is also piped in parallel to increase capacity.

FIGS. 5A-5C are piping and instrumentation diagram of a salt-water disposal facility with a cavitation fluid treatment system with a plurality of auxiliary steam-powered processes. FIG. 5A shows a salt-water disposal facility 500 with auxiliary steam process systems 551, 552, 553, 554, 541, 542, 571, 572 incorporated into the salt-water treatment process.

FIG. 5B shows a preheated cavitation fluid treatment system 200 providing steam in conduit 50 to a heat exchanger 170 and axillary steam in conduit 51 to an absorption chiller 551, a condenser 552, a process heater 553, and a steam drive 554. FIG. 5B also shows auxiliary steam in conduit 51 provided to fluid heating devices 572, 573, which are shown in more detail in FIG. 5C. Returning to FIG. 5B, the absorption chiller 551 can utilize the auxiliary steam flow to produce chilled water. This chilled water can be used to further cool building spaces or other process equipment. The condenser 552 inputs the flow of auxiliary steam from conduit 51 and removes thermal energy from auxiliary steam until a flow of condensed fresh water in conduit 90 is produced. The process heater 553 uses the auxiliary steam from conduit 51 to heat a flow of process fluid from conduit 81, whereby a flow of process fluid from conduit 81 enters the process heater 553, absorbs thermal energy from the auxiliary steam from conduit 51, and exits the process heater 553 as a heated process fluid in conduit 52. Additionally, the auxiliary steam from conduit 51 in some instances leaves the process heater 553 as a flow of condensed fresh water in conduit 90.

Continuing to refer to FIG. 5B, the steam drive 554, which in some instances, for example, is a steam turbine or steam piston motor, accepts the auxiliary steam from conduit 51, generates mechanical energy, and outputs condensed fresh water in conduit 90. The mechanical energy in some instances is used, for example, to drive a mechanical device or a generator to generate electrical power 20. The mechanical device in some instances is, for example, the cavitation reactor 130, whereby mechanical energy from the steam drive 554 supplements the cavitation motor 131. In some instances, the generated electrical power 20 is input to the feed motor 121 or cavitation motor 131 to reduce the overall required electrical input to the salt-water disposal facility 500. In some instances, a steam dryer (not shown) is included prior to the steam drive 554 in order to reduce the liquid vapor content of the auxiliary steam in conduit 51 and deliver, for example, 99% dry steam to the steam drive 554.

FIG. 5C shows various steam heaters 571, 572, 573, 542, and mixer or agitator 541 powered by the auxiliary steam 51. The skim oil storage tank 470 includes a steam heater 573, which in some instances is a steam jacket around the skim oil storage tank 470 or a steam trace line, accepting the flow of auxiliary steam from conduit 51 and transferring thermal energy from the auxiliary steam from conduit 51 to the skim oil storage tank 470 or to the skim oil in conduit 70 directly. The steam heater 573 in some instances is used to prevent coagulation of the skim oil in conduit 70 or in the skim oil storage tank 470, or, similarly, to improve the egress of skim oil in conduit 70. A similar concept is used by the steam trace pipe 571 or steam jacket pipe 572 that carries the skim oil in conduit 70 from the skim oil storage tank 470. In the steam trace pipe configuration, a conduit 571 of auxiliary steam from conduit 51 runs along the conduit 70 carrying the skim oil, and transfers thermal energy to conduit 70. In the steam jacket pipe 572, a concentric conduit surrounds the conduit 70 carrying the skim oil and enables a flow of auxiliary steam from conduit 51 to surround the conduit 70 carrying the skim oil. Steam tracer or steam jackets in some instances are used to heat pipe or tanks to prevent freezing or coagulation in tanks and pipes. Heating pipes in some instances also aid in transfer of fluid.

Continuing to refer to the auxiliary steam devices in FIG. 5C, the gun barrel separator 442 includes an insertion heater 542 that accepts the auxiliary steam from conduit 51 and heats the contaminated feedstock in the gun barrel separator 442. The insertion heater 542 in some instances prevents the contained feedstock from freezing in the gun barrel separator 442 or improve the separation of the skim oil. The insertion heater 542 returns a flow of condensed fresh water in conduit 90. The gun barrel separator 442 also includes a steam driven agitator or mixer 541 utilizing the auxiliary steam from conduit 51 to drive the motion of the agitator or mixer 541. In some instances, the mixer or agitator 541 is used to increase the separation of oil from the salt-water.

A number of implementations have been described. Nevertheless, it will be understood that various modifications may be made. Accordingly, other implementations are within the scope of the following claims.

What is claimed is:

1. A well fluid treatment system, the system comprising:
a cavitation reactor comprising a reaction chamber housing, a rotor and a stator mounted in the reaction chamber housing, a well fluid inlet into the reaction chamber housing and a heated fluid outlet from the reaction chamber housing, the cavitation reactor configured to cause cavitation of a flow of well fluid received through the well fluid inlet and transfer sufficient thermal energy to the flow of well fluid to convert at least a portion of water in the well fluid to steam in a single pass of the well fluid through the cavitation reactor;
a steam-liquid phase separator comprising a separator housing, a heated well fluid inlet into the separator housing, a steam outlet from the separator housing, and a residual outlet from the separator housing, the heated well fluid inlet coupled to the heated fluid outlet to receive the flow of heated well fluid from the cavitation reactor, the steam-liquid phase separator configured to separate the flow of heated fluid into steam and a condensed contaminated fluid; and
an auxiliary system coupled to the steam outlet to receive a flow of steam, the auxiliary system adapted to transfer thermal energy from the flow of steam to one or more of the following: (a) a well fluid treatment process before the cavitation reactor, or (b) a condensed contaminated fluid treatment process after the cavitation reactor.

2. The system of claim 1, wherein the cavitation reaction is a continuous cavitation reactor, the continuous cavitation reactor adapted to heat an uninterrupted flow of the well fluid to an uninterrupted flow of steam.

3. The system of claim 1, wherein the auxiliary system comprises a steam tracing system comprising a plurality of steam conduits adapted to variably transfer thermal energy from the flow of steam to adjacent fluid conduits of the well fluid treatment system, the steam tracing system enabling temperature regulation of a fluid in the adjacent fluid conduits.

4. The system of claim 1, wherein the auxiliary system comprises a heating system of the phase separator, the heating system adapted to regulate the temperature of fluids in the phase separator using thermal energy from the flow of steam.

5. The system of claim 1, wherein the auxiliary system comprises a heat exchanger adapted to heat the flow of well fluid prior to the cavitation reactor.

6. The system of claim 1, wherein the well fluid contains oil, and wherein the phase separator is further adapted to separate the oil from the condensed contaminated fluid.

7. The system of claim 6, wherein the auxiliary system comprises a heating system adapted to dry the condensed contaminated fluid and separate remaining water from the oil.

8. The system of claim 1, wherein the well fluid contains salt.

9. The system of claim 1, further including a condenser for receiving the flow of steam, the condenser adapted to generate a liquid water from the received flow of steam.

10. The system of claim 1, wherein the thermal energy transferred to the flow of well fluid in a single pass is sufficient to convert at least a 50% of the water in the well fluid to steam at atmospheric pressure.

11. The system of claim 1, wherein the auxiliary system is an absorption chiller adapted to convert the thermal energy from the flow of steam to chill a fluid.

12. A method of treating well fluid, the method comprising:
causing cavitation in a flow of well fluid through a cavitation reactor, the cavitation heating the flow of well fluid to a temperature sufficient to convert at least a portion of water in the well fluid to steam in a single pass of the well fluid through the cavitation reactor;
separating the flow of heated fluid into steam and a condensed contaminated fluid; and
transferring thermal energy from the flow of steam to an auxiliary process doing one or more of the following: (a) treating the well fluid before the cavitation reactor, or (b) treating the condensed contaminated fluid after the cavitation reactor.

13. The method of claim 11, where causing cavitation in a flow of well fluid comprises continuously causing cavitation in an uninterrupted flow of well fluid.

14. The method of claim 11, wherein the auxiliary process flows the steam through a plurality of steam conduits adjacent to fluid conduits of the well fluid treatment system, the axillary process regulating the temperature of a fluid in the adjacent fluid conduits.

15. The method of claim 11, wherein the auxiliary process comprises regulating the temperature of one or more fluids in a phase separator receiving the flow of heated fluid.

16. The method of claim 12, comprising:
converting thermal energy from the flow of steam into mechanical energy; and
partially causing the cavitation with the mechanical energy.

17. The method of claim 12, wherein the auxiliary process comprises heating the flow of well fluid prior to the cavitation reactor.

18. The method of claim 12, wherein the well fluid contains oil, and wherein separating comprises separating the oil from the condensed contaminated fluid.

19. The method of claim 18, wherein the auxiliary process comprises agitating the well fluid prior to the cavitation reactor, the agitating separating at least some of the oil from of well fluid prior to the cavitation reactor.

20. The method of claim 12, comprising heating the flow of well fluid with the cavitation reactor in a single pass to a temperature sufficient to convert at least 50% of water in the well fluid to steam at atmospheric pressure.

21. The method of claim 12, wherein the auxiliary process comprises flowing the steam into an absorption chiller, the absorption chiller generating chilled water.

22. A well fluid treatment system, the system comprising:
a cavitation reactor adapted to cause cavitation of a flow of well fluid received through the well fluid inlet and to heat the flow of well fluid to a temperature sufficient to convert at least a portion of water in the well fluid to steam in a single pass of the well fluid through the cavitation reactor;
a steam-liquid phase separator adapted to separate the flow of heated fluid into steam and a condensed contaminated fluid; and
an auxiliary system coupled to the steam outlet to receive a flow of steam, the auxiliary system adapted to transfer thermal energy from the flow of steam to one or more of the following: (a) a well fluid treatment process before the cavitation reactor, or (b) a condensed contaminated fluid treatment process after the cavitation reactor.
